(19) United States
(12) Patent Application Publication
(10) Pub. No.: US 2025/0345148 A1
(43) Pub. Date: Nov. 13, 2025

(54) ORTHODONTIC STRIP, SPACE MEASURING DEVICE, AND METHOD

(71) Applicant: Michael J Florman, Garden Grove, CA (US)

(72) Inventor: Michael J Florman, Garden Grove, CA (US)

(21) Appl. No.: 19/203,153

(22) Filed: May 8, 2025

Related U.S. Application Data
(60) Provisional application No. 63/643,929, filed on May 8, 2024.

(51) Int. Cl. A61C 3/00

(52) U.S. Cl. CPC A61C 3/00

(57) ABSTRACT

An orthodontic member for attaching to the brackets or axillary orthodontic products associated with an orthodontic appliance includes a tray or strip-shaped member forming a flexible substantially U-shaped channel. The channel is sized to seat around the brackets of braces and is shaped to be held in place on the brackets without additional assistance. The tray is for holding an ingredient or being coated with an ingredient for transmission to the teeth, gums or orthodontic appliances. The member also includes at least one flap attached to one or more of the upper edge of the tray or the lower edge of the tray, said flap being sized to cover at least part of the teeth and/or gums of the patient.

### CROSS-REFERENCE TO RELATED APPLICATION

This application claims priority to U.S. Provisional Application No. 63/643,929, filed May 8, 2024, the disclosure of which is incorporated herein by reference in its entirety.

### FIELD

The present invention concerns an orthodontic strip for placing over the brackets of braces, a space measuring device and a method of attracting customers to try teeth realignment.

### BACKGROUND

Children who wear braces notoriously are known for bad dental hygiene. It is desirable to provide an easy to wear solution that provides the user with benefits than can improve their overall oral health.

Dentists measure spaces between teeth for various reasons. Current space measuring devices are either single strips of material with a defined thickness that when wedged into a space either fits or is too large. The user needs to then fumble between different “leafs” until he/she finds one that fits. If the leaf is too large, it will not fit, and if the leaf is too small it will fit too loosely. This system is cumbersome, and inaccurate.

### SUMMARY

An orthodontic member for attaching to the brackets or axillary orthodontic products associated with an orthodontic appliance includes a tray or strip-shaped member forming a flexible substantially U-shaped channel. The channel is sized to seat around the brackets of braces and is shaped to be held in place on the brackets without additional assistance. The tray is for holding an ingredient or being coated with an ingredient for transmission to the teeth, gums or orthodontic appliances. The member also includes at least one flap attached to one or more of the upper edge of the tray or the lower edge of the tray, said flap being sized to cover at least part of the teeth and/or gums of the patient.

The member may be configured to deliver an ingredient to the gums, teeth and orthodontic appliances. The member may be made from a flexible material that is compatible with the oral cavity and harmless to patient. The member may be fabricated from plastic materials or rubber materials. The member may be fabricated of silicone or ethyl vinyl acetate.

The member may be colored or includes a pattern or artwork that is aesthetically pleasing to children. The flap may cover at least part of the gingival tissue on the facial surface of the tooth. The member may deliver the ingredient in the form of a gel, foam, spray, liquid, cream or other generally accepted oral care active ingredient. The member may be re-usable and includes instructions to the patient to clean after use and repeat the procedure. The member may be disposable. The member may be dissolvable. The member may be coated with an ingredient by spraying, dipping, layering, powdering, and adhering ingredients thereto. The ingredient may be medicaments from oral care categories that include one or more of anti-caries, anti-dry mouth, anti-halitosis, enamel re-mineralizing and strengthening, anti-tooth sensitivity, and tooth whitening.

The surface of the member may include surface treatments to aid in the adhering of ingredients thereto. The member may be disposable, may be extruded from plastic and may have a medicament sprayed onto the surface thereof. The member may be extruded from other polymers and contain wax-like properties that contain therapeutics imbedded in their matrix.

### BRIEF DESCRIPTION OF THE DRAWINGS

FIG. 1 depicts a front view of a first embodiment of the invention in the form of strips or trays applied to brackets of braces in the mouth;

FIG. 2 depicts a cross-sectional side view of strips or trays according to the invention;

FIG. 3 depicts a side view similar to that in FIG. 1;

FIG. 4 depicts a pair of trays or strips according to the invention;

FIG. 5 depicts a spacing measurement tool according to the invention;

FIG. 6 depicts an alternative spacing measurement tool according to the invention;

FIG. 7 depicts an alternative spacing measurement tool according to the invention;

FIG. 8 depicts a linear measuring tool having a 90 degree bend according to the invention;

FIG. 9 depicts a linear measuring tool according to the invention; and

FIG. 10 depicts a linear measuring tool according to the invention having a bend in the middle.

### DETAILED DESCRIPTION

The present disclosure concerns several different dental advances. A first advance concerns the use of orthodontic strips that can be treated to improve oral health of patients who wear braces. A second advance concerns a space measuring device for measuring spaces between teeth. A third advance concerns a business method.

The first advance discussed herein concerns an orthodontic strip that can be treated and applied to orthodontic brackets in the mouth. The strips seat on orthodontic brackets and may extend to cover parts of the teeth and gums. The strips are formed as form-fitting trays or strips that affix to the brackets of braces. The strips serve as carriers for ingredients that are beneficial to a patient's oral health.

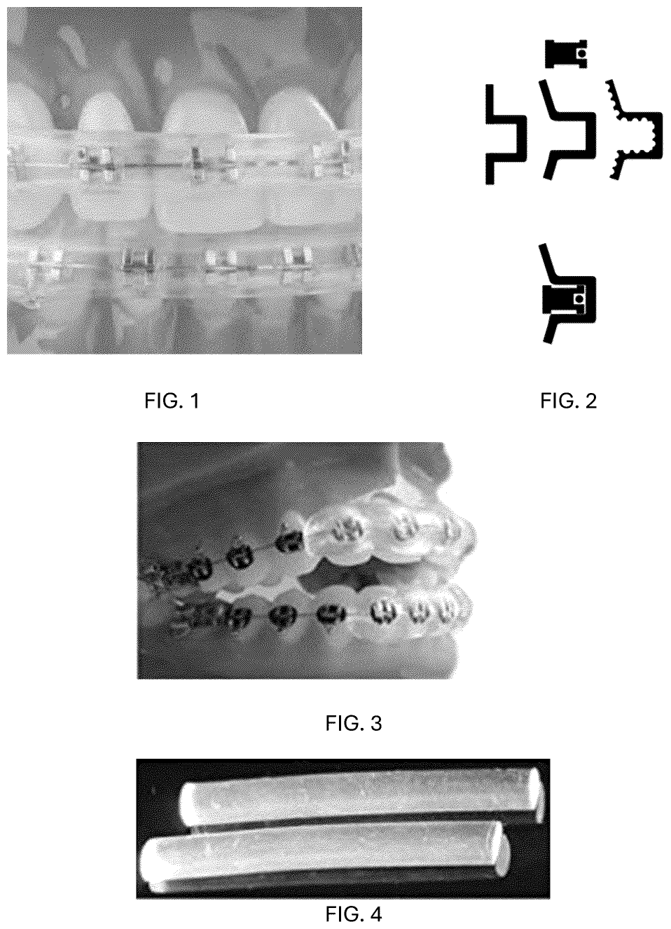

FIGS. 1-4 depict a orthodontic strip according to the invention. FIG. 1 depicts the trays/strips installed over the brackets of a user's braces for both the upper and lower teeth. FIG. 2 depicts various configurations of the strips in cross-section. FIG. 3 depicts an alternative view of the strips/trays installed over brackets of braces, with the strips installed over the front six teeth, and FIG. 4 depicts the individual strips when not applied to brackets.

As shown, the trays or strips affix to the brackets of orthodontic appliances. They can be made in strips so that they cover multiple brackets at a single time. They may be sized to seat over multiple teeth, all the teeth, or single teeth. The strips may hold ingredients to deliver medicaments to the gums, teeth and orthodontic appliances. The appliances may be orthodontic brackets or axillary orthodontic products that fit on brackets, bands, wires, or ligature ties.

The strips are made of a flexible material that is compatible with the oral cavity and harmless to patient. The strips may be fabricated from plastics or rubbers. An example of types of materials that may be used include silicone or ethyl vinyl acetate. The materials may be clear, foggy, opaque, or colored. Since about ⅔rds of braces are worn by children, the material can include aesthetics that are pleasing to children, such as colors, flowers, animals, sports images (such as balls, sports team logos, and the like), university names, and mascots. Like colored rubber bands, the strips may be used as a “fashion statement” for children who wear braces while still providing benefits to the oral health of the patient. The aesthetics can be in molded or printed on the exterior surfaces of the strips. The material of the strips can also be color.

The strips/trays comprise three parts: a U-shaped part that the orthodontic bracket fits into, an upper extension of the U-shaped part that covers a part of the tooth above the orthodontic appliance, and a lower extension of the U-shaped part that covers the part of the tooth below the orthodontic appliance.

The upper extension can also cover part or all of the gingival tissue on the facial surface of the tooth. The lower extension can also cover part or all of the gingival tissue on the facial surface of the tooth.

The strip/tray may deliver a gel, foam, spray, liquid, cream or other generally accepted oral care active ingredient. The tray/strip may be re-usable with instructions to the patient to clean after use and repeat the procedure. Alternatively, the tray or strip can be made disposable with instructions to the patient to use once and dispose of after use.

The strip/tray can be provided in single use packaging which is sold to patients in packs, ranging from 2-5,000 units. A range of 2-730 units may be desirable for a year supply, a range of 2-365 for a half year, or 2-60 for one month's supply. The tray or strip may be fabricated from a material that dissolves in the patient's mouth over time, aiding enhancing patient's compliance by simplifying the process.

Both or one of the surfaces of the tray or strip can be coated. The strip can be coated by spraying, dipping, layering, or powdering. Adhesive chemicals that are orally safe may be used. Medicaments from various oral care categories may be used. Examples include anti-caries, anti-dry mouth, anti-halitosis, enamel re-mineralizing and strengthening, anti-tooth sensitivity, tooth whitening, and the like.

A surface of the trays or strips may be textured or contain undercuts to allow for the coatings to adhere to the strips. An example of texture may include a surface that is stippled, waved, or ribbed. The surface may have raised and lowered folds to increase surface area, similar to an accordion. The surface can have tiny holes that protrude into either the top or bottom of the tray or strip, or holes that traverse through to both sides.

Disposable strips may be made in the shape shown in FIGS. 2 and 4. The strips may be extruded from plastic and have medicament sprayed onto the surface like a tooth whitening strip. The strips may be extruded from other polymers and contain wax-like properties that contain therapeutics imbedded in their matrix.

Referring to FIG. 2, FIG. 2 depicts various designs for the strip shown in cross-section. A bracket is shown at the top of FIG. 2. A U-shaped portion of the tray/strip is shown as having an upper portion and lower portion, as well as a portion that seats over the bracket. The upper portion and the lower portions extend over the teeth and extend towards the gingiva. The strip may include an internal surface shape that aides in attachment to an underlying bracket. In particular, as shown in FIG. 2, barbs may be positioned on an underside of the strip. The barbs help to increase the internal surface area to allow for agents to adhere to the larger surface area created by the barbs.

The tray or strip may include embedded ingredients that are delivered over time to a user. Certain highly reactive ingredients need to be kept isolated from other ingredients to prevent their breakdown or chemical changes that may leave them inactivated or altered into a form that does not provide therapeutic benefit. Preparing therapeutic formulations that combine more than one active ingredient have used dual chamber vessels that allow the user to expel the two ingredients at the same time, and or expel the ingredients and mix the ingredients as they are expelled. Another method of combining ingredients needing separation until use is to keep the actives in separate vessels until use, expelling the ingredients one after the other, on top of or side by side each other. When compressed together against the target area, they mix. By varying the thickness of the carrier base containing the active ingredients, the active ingredient can be suspended, regardless of whether the active ingredient dissolves into the carrier base. The thicker the base, the more suspended the active ingredient, and the less reaction between the active ingredients that are suspended. The present invention may used suspended ingredients that become active after a layer is dissolved away due to contact with saliva or water in the mouth.

In another embodiment, an instrument is provided to measure space between teeth. Current space measuring devices are either single strips of material with a defined thickness that when wedged into a space either fits or is too large. The user needs to then fumble between different “leafs” until he/she finds one that fits. If the leaf is too large, it will not fit, and if the lea is too small it will fit loosely. This system is cumbersome, and inaccurate.

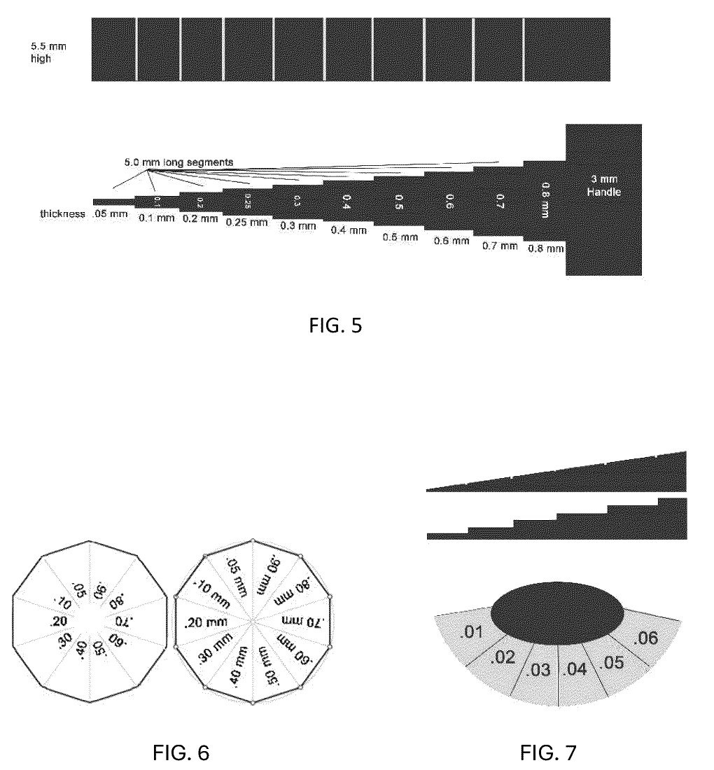

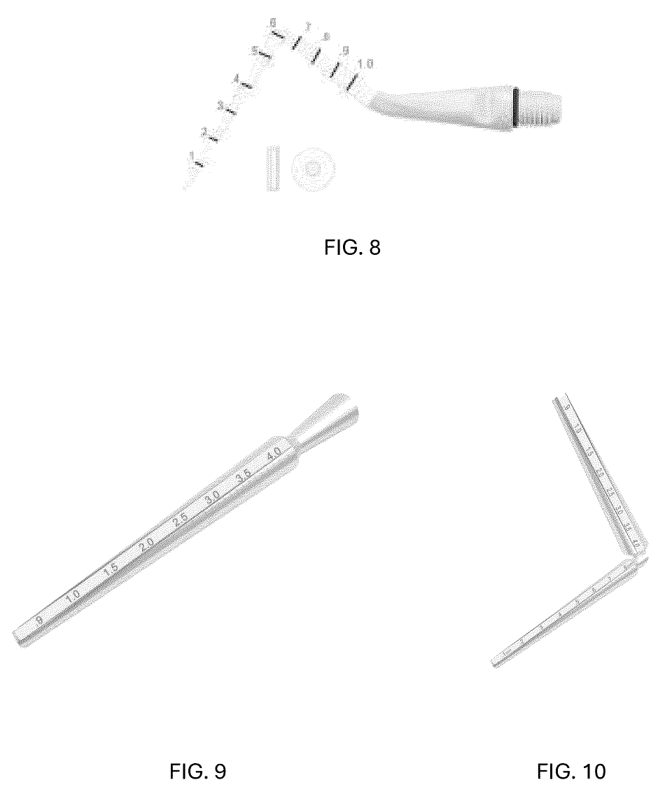

One version of the invention utilizes a member that is tapered, as shown in FIGS. 8-10. Another version of the invention uses a member that is stepped, as shown in FIGS. 5-7.

Each member has a defined starting thickness, ending thickness, and range. The range can be sequential or non-sequential increments. The range is about 0.025 mm to about 10 mm. Depending on the desired length of the member, multiple members can be devised with smaller ranges. For example, one member may begin at about 0.025 mm and end at about 0.5 mm, and can be sequential stepped by 0.025 mm increments. Another example can be a member ranging from about 0.1 mm to about 0.5 mm, with 0.1 mm increments. Yet another example of a member may range from about 1 mm to about 10 mm, with 1 mm increments. The tapered member may offer the user more incremental measurements as compared to the stepped member.

In a linear version of the member, there are the following dimensions:
Member length—The length of the member can range from about 5 mm to about 100 mm. A more useful length would be about 30 mm to about 50 mm. An even more useful length would be about 40 mm.
Member height—The height of the member can range from about 0.025 mm to about 10 mm, with about 5 mm to 7 mm being preferred.

In a circular version of the measuring device, as shown in FIG. 7, the member can segmented in equal length “pie segments”. The circular version can be a whole circle or a portion of a circle. A handle can be attached to the partial circle. No handle is needed in a full circle version as the user will grasp the portion of the circle he/she is not using when measuring. A polygon version of the member, as shown in FIG. 6, can be segmented similar to the circle member. The polygon member can be segmented in as little as 3 segments up to 20 segments. The most ideal polygon shape is a decagon with 10 sides. Each side represents a different thickness.

The round or polygon shaped member can have a recess in the center or perforation that allows the user to spin the member using one hand (two fingers holding the member using the center recess or hole, and one finger to spin the member while taking measurements.

The linear member can have a single handle, or two or three members can be connected together creating a pseudo handle. Two linear members, as shown in FIGS. 8-10, can connect forming an angle ranging from 30 degrees to 180 degrees.

Another handle can be affixed to either the straight member or the member consisting of two members attached to each other that can range from about 0.25 inch to about 10 inches. The thickness of this handle can range from about 2 mm to about 4 mm. The linear member can be configured to bend into two halves or sections, as shown in FIG. 10.

According to another aspect of the invention, the largest provider of clear aligners, Align Technology™, makers of the Invisalign Clear Aligner System™, sells approximately 1,200,000 clear aligner cases through doctors for patients in the United States annually.

There are approximately 156,000 dental offices, and on average, this amounts to 7.7 aligner cases per year, per office and 0.64 aligner patient cases per month, per office.

Considering that there are only approximately 60,000 dental offices in the U.S. that perform and offer Invisalign to their patients, this equates to an average of 20 orthodontic Invisalign cases per year, per office that provides orthodontic treatment.

There are 1,000 patients on average for each of the 156,000 dental offices, equaling a total 156,000,000 patients being seen in the U.S. by dentists for any type of treatment.

The question arises, if there are 156,000,000 patients in the U.S. seeing the dentist, and 90% of them have crooked or spaced teeth, why can Invisalign after 25 years building the market only treat less than one percent (0.78%) of the total patients seeing the dentist.

Out of the 156,000,000 patients being treated by the 156,000 dental offices, patients with crooked teeth account for 140,000,000 patients (90% or 9 out of 10 patients have some crooked or spaced teeth or bite problem).

The majority of dentists do not care to mention to the patents that there is orthodontic treatment available using Invisalign. In the past, 25 years ago, adult patients would never wear braces to straighten their teeth, and dentists knew that, so they treated minor and moderate orthodontic cases as normal, and just cleaned around the crooked teeth, telling patients to floss and brush better. Even though Invisalign treatment exists now, old habits are hard to break, and orthodontic treatment is just not discussed as most general dentists do not perform orthodontic treatment, and do not want to perform orthodontic treatment. Hence, why there are 140,000,000 potential patients who have not been treated.

The following invention will quickly allow companies like Invisalign to increase their market size from 1.2 million patients being treated to double or triple this number very quickly. The following technique is designed to move patients into orthodontic treatment who would have never been moved before.

The technique involves utilizing a digital scanner that is capable of capturing 3D, color images of a patient's teeth in a dental office. The method involves scanning a percentage of all patients in the dental practice over a period of time (T1). The digital scan is saved as an .STL file or other file, which is the current dental industry standard for complete 3D models of the jaw, teeth, and gums. The digital scan is sent to a processing facility (hereinafter “the Service”). Using existing AI, such as the Invisalign Clincheck™ software, the teeth are moved and straightened electronically in the computer. A before and after set of images is then generated along with a video showing the teeth moving in real time step by step until the orthodontic problem is corrected. This is designed to give the patient an idea of what an alignment procedure can do and the necessary steps along the way.

The same STL file will also be evaluated by dentists. Using AI, each tooth will be separated from the 3D model and examined for the following items:
Tooth discoloration and identification of the patients' teeth shade.
Old dental restorations that look suspicious or in possible need of repair.
Missing teeth that need to be replaced.
Gingival recession on all teeth surfaces of each tooth.

A complete orthodontic work-up describing overjet, overbite, crowding, spacing, molar classification, tooth size discrepancies (Bolton Analysis), midline relative to lip philtrum, will also be conducted.

Thereafter, a detailed digital report will be generated for each patient which can also include radiographic information submitted with the digital scan to the Service. Other information can be submitted, such as insurance information, at the same time.

A setting under the dentists profile can be programmed to inform the Service to send these digital reports to the patient or to the doctor. In the case where the report is sent to the doctor, an Active Form can list all the findings for on every tooth, with a request for the doctor to include the teeth and findings found to the patient, in a customized report the dentist may edit before sending. In this report, a before and after orthodontic Clincheck™, or before and after images may be provided.

The patient report and edited patient report can be cataloged into the doctor's practice management patient charting system for storage and retrieval. The report sent to the patient is also an Active Form that requests the patient answer questions pertaining to the findings.

### EXAMPLE

Tooth number 3 has an old broken filling but seems sound for now. We will be watching this tooth.

Tooth number 14 has a cracked cusp, and needs a crown.

Your are wearing down your teeth and you would benefit from a night guard.

Your teeth shade is registered as a B3. Tooth whitening is recommended to improve your overall teeth appearance.

Your orthodontic condition has been evaluated and you can benefit from Invisalign. The treatment will take 6 months, and cost 5,000, not including any insurance benefits we know about at the time this report is generated.

Teeth numbers 23, 24, 25 and 26 can use minor cosmetic bonding to improve the chips and cracks (pictures will show these cracks).

You should consider getting your wisdom teeth extracted where you cannot brush properly.

Teeth number 23 has 3 mm of gingival recession we need to monitor.

Tooth number 12 is missing and you may be a candidate for a dental implant. Would you like us to look into your insurance to see if you have any benefits this year?

The Service can reach out to the patient on behalf of the dentist and interact, driving communication pertaining the treatment options. The Service can also call the patient on behalf of the dentists to inquire if they are interested in any of the treatment analyzed by the Service (and or the dentist). At follow up visits, a new scan can be taken and sent to the Service for comparative analysis to demonstrate if any new problems have occurred, or any existing problems have worsened. A digital comparison of each tooth on all visual surfaces can be compared using AI and any differences can be reported to the dentist and patient. In cases where no changes have occurred, a congratulations email can be sent indicating this.

The Service becomes a new tool to educate patients, track dental findings, motivate patients to comply with dental treatment, and drive more orthodontic treatment that would never have even been discussed with the patient. If an office has 1,000 active patients, the Service can catalog images of all 28,000 teeth the dentist needs to care for. No system exists today that performs a detailed evaluation of all the teeth, document findings, market the findings to the patient, and drive dental business. No other system exists today that can take multiple full scans and compare and contrast them to scans performed on a later date.

For dentists that have scanners, none of them are using them to scan every patient, nor do they have a place to send the data for analysis and evaluation. Moreover, dental offices don't have the bandwidth to review all the data. This all becomes possible with the Service.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the aspects described are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. An orthodontic member for attaching to the brackets or axillary orthodontic products associated with an orthodontic appliance comprising:
a tray or strip-shaped member forming a flexible substantially U-shaped channel, with the channel being sized to seat around the brackets of braces and shaped to be held in place on the brackets without additional assistance, said tray for holding an ingredient or being coated with an ingredient for transmission to the teeth, gums or orthodontic appliances;
at least one flap attached to one or more of the upper edge of the tray or the lower edge of the tray, said flap being sized to cover at least part of the teeth and/or gums of the patient.

2. The member of claim 1, wherein the member is configured to deliver an ingredient to the gums, teeth and orthodontic appliances.

3. The member of claim 1, wherein the member is made from a flexible material that is compatible with the oral cavity and harmless to patient.

4. The member of claim 1, wherein the member is fabricated from plastic materials or rubber materials.

5. The member of claim 4, wherein the member is fabricated of silicone or ethyl vinyl acetate.

6. The member of claim 1, wherein the member is colored or includes a pattern or artwork that is aesthetically pleasing to children.

7. The member of claim 1, wherein the flap covers at least part of the gingival tissue on the facial surface of the tooth.

8. The member of claim 1, wherein the member delivers the ingredient in the form of a gel, foam, spray, liquid, cream or other generally accepted oral care active ingredient.

9. The member of claim 1, wherein the member is re-usable and includes instructions for the patient to clean after use and repeat the procedure.

10. The member of claim 1, wherein the member is disposable.

11. The member of claim 1, wherein the member is dissolvable.

12. The member of claim 1, wherein the member is coated with an ingredient by spraying, dipping, layering, powdering, and adhering ingredients thereto.

13. The member of claim 1, wherein the ingredient is medicaments from oral care categories that include one or more of anti-caries, anti-dry mouth, anti-halitosis, enamel re-mineralizing and strengthening, anti-tooth sensitivity, and tooth whitening.

14. The member of claim 1, wherein the surface of the member includes surface treatments to aid in the adhering of ingredients thereto.

15. The member of claim 1, wherein the member is disposable, is extruded from plastic and has medicament sprayed onto the surface thereof; or is extruded from other polymers and contains wax-like properties that contain therapeutics imbedded in their matrix.
